(19) United States
(12) Patent Application Publication
(10) Pub. No.: US 2003/0089888 A1
(43) Pub. Date: May 15, 2003

(54) Use of aqueous brightener preparations for brightening natural and synthetic materials

(76) Inventors: Erwin Bacher, Bergisch Gladbach (DE); Rolf Brockmann, Bergisch Gladbach (DE); Heinz Giesecke, Odenthal (DE); Reiner Gottschalk, Koln (DE); Peter-Roger Nyssen, Dormagen (DE)

Correspondence Address: BAYER CORPORATION, PATENT DEPARTMENT, 100 BAYER ROAD, PITTSBURGH, PA, 15205, US

(21) Appl. No.: 10/251,561

(22) Filed: Sep. 20, 2002

(30) Foreign Application Priority Data
Oct. 5, 2001 (DE) 10149313.4

(51) Int. Cl. C09K 11/06

(52) U.S. Cl. 252/301.21

(57) ABSTRACT

The invention relates to a method of optically brightening natural or synthetic materials with aqueous brightener preparations containing

(a) 15 to 85% by weight of at least one water-soluble optical brightener, and

(b) optionally 85 to 15% by weight of water,

wherein the temperature of the preparation is 40 to 98° C.

### BACKGROUND OF THE INVENTION

The invention relates to the use of aqueous preparations of optical brighteners for brightening natural and synthetic materials, processes for their preparation, and processes for the optical brightening of paper.

The optical brightening of paper is used in the pulp, in the size press or film press, and in the paper coating. Particularly in the brightening of paper in the pulp, it is now increasingly necessary to take account of ecological aspects (for example, in the sense of avoiding organic wastewater loads) and economic aspects (for example, in terms of economical processes). The use of liquid brightener formulations, either in the form of solutions or in the form of suspensions, also referred to as slurries, is part of the prior art.

Stilbene brighteners containing sulfo or carboxyl groups, particularly triazinylstilbene brighteners, which on the one hand are often distinguished by good substantivity and on the other hand are correspondingly characterized by limited solubility in cold water, are preferably used. In purely aqueous solutions, these brighteners tend to form crystalline precipitates even at low concentrations and ambient temperature (<40° C.). Aqueous solutions having a long shelf life, as described, for example, in DE-A 2,928,053 therefore additionally contain considerable amounts of standardizing agents, solubilizers, such as, for example, urea, and/or organic solvents, such as, for example, polyalkylene glycols.

As a remedy, DE-A 2,715,864 therefore describes “slurries” (i.e., suspensions) of optical brighteners, which are prepared by mixing the water-moist brightener press cakes with dispersants and optionally adding electrolyte, organic extenders (urea, for example) and gelling agents. However, as disclosed in EP-A 385,374, these slurries are not stable to sedimentation over a long period. EP-A 385,374 therefore describes aqueous suspensions of the optical brighteners in the form of their free acids or their salts for use in liquid detergents, which suspensions are stabilized against sedimentation by adding an anionic polysaccharide (thickener). Similar, anionic formulations of the free acids of the optical brighteners, which formulations contain polyhydroxy compounds, are described in EP-A 835,906 for use in paper. However, with regard to their economical use, particularly for brightening paper in the pulp, these suspensions still have disadvantages. Thus, the brightener crystals must be subjected to wet milling to a particle size of <20 μm (particularly <10 μm) and the solubility in water may be achieved only by adding alkali.

In addition, DE-A 2,715,864 describes the advantages with regard to the dust behavior of slurries over dry powders that are obtained by drying and milling the water-moist press cakes.

DE-A 3,523,207 describes solid brightener preparations with a low dust content for use in textile dyeing baths. These preparations are obtained by mixing a spray-dried optical brightener formulation with an aromatic carboxylic ester or fatty acid polyol ester and are distinguished by good solubility in hot water (80° C.). However, such solutions do not have long-term stability to crystalline precipitation at relatively high concentrations.

Common to all methods of the application of optical brighteners in paper is that preparations of the optical brighteners that are tailored for sufficient stability and use at normal temperature and that, in addition to the “active ingredient” of the optical brightener itself, also require further auxiliaries undesired for the paper process are used. Thus, suspensions and slurries generally require organic dispersants and stabilizers, and solid preparations often require extenders and/or dedusting agents. Known solutions of optical brighteners that have sufficient long-term stability at normal temperature are limited with regard to their concentration to about 20% and require a large amount of standardizing agent and/or cosolvent.

Surprisingly, it has now been found that aqueous brightener preparations, particularly solutions of optical brighteners, can be introduced into water considerably more easily and rapidly at a temperature of 40° C. to 98° C. in comparison with solid preparations. The aqueous preparations to be used according to the invention preferably have a high content of optical brightener, are preferably substantially free of undesired organic components, and are preferably free of crystalline brightener particles, particularly their hydrate forms. They are therefore very suitable for the continuous and batchwise brightening of synthetic or natural materials, preferably fiber materials, particularly paper in the pulp and/or on the surface.

### SUMMARY OF THE INVENTION

The invention therefore relates to a method comprising optically brightening natural and synthetic materials (preferably fiber materials, particularly paper in the pulp and/or on the surface) with an aqueous brightener preparation comprising

(a) 15 to 85% by weight (particularly 20 to 65% by weight) of at least one water-soluble optical brightener, and

(b) optionally (and preferably) 85 to 15% by weight of water,

wherein the temperature of the aqueous brightener preparation is 40-98° C. (preferably 60-95° C.).

### DETAILED DESCRIPTION OF THE INVENTION

In this application, “water-soluble” is understood as meaning a solubility of >0.1 g/l (preferably >1 g/l, particularly >5 g/l) at 20° C.

In a preferred embodiment, the brightener preparation contains more than 90% by weight (preferably more than 95% by weight, particularly preferably more than 98% by weight) of the components (a) and (b).

The aqueous brightener preparations are in general liquids.

The optical brighteners of component (a) are preferably anionic or cationic brighteners, particularly brighteners from the group consisting of the brighteners containing sulfo and/or carboxyl groups (particularly from the group consisting of the stilbene compounds, very particularly preferably distilbenes) or of the triazinylflavonates of general formula (I)

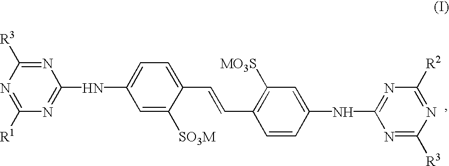

in which

R¹, R², and R³, independently of one another, denote phenoxy; mono- or disulfonated phenoxy; phenylamino; mono- or disulfonated phenyl-amino; phenylamino substituted by C₁-C₃-alkyl, cyano, halogen, COOR, CONH—R, NH—COR, SO₂NH—R, or O—R; morpholino; piperidino; pyrrolidino; —O(C₁-C₄-alkyl); —NH(C₁-C₄-alkyl); —N(C₁-C₄-alkyl)₂; —NH(C₂-C₄-alkylene)—OR; —N(C₂-C₄-hydroxyalkyl)₂; —NH(C₂-C₄-alkylene)—O—(C₂-C₄-alkylene)—OR; an amino acid or an amino acid amide from which a hydrogen atom has been removed from the amino group; —NHCH₂CH₂OH; —N(CH₂CH₂OH)₂; —N(CH₃)(CH₂CH₂OH); —NH₂; —OCH₃; —S—C₁-C₄-alkyl; —S-aryl; —Cl; —NH—CH₂CH₂SO₃H; —N(CH₂CH₂SO₃H)₂; or —N(CH₂CH₂OH)CH₂CH₂CONH₂, and

R denotes H or C₁-C₃-alkyl, and

M denotes the radical of an alkali metal, alkaline earth metal, ammonium, or amine salt.

Preferred among amine salt ions are those of the formula H^{⊕}NR⁴R⁵R⁶ in which R⁴, R⁵, and R⁶, independently of one another, denote hydrogen, alkyl, alkenyl, hydroxyalky, cyanoalkyl, halogenoalkyl, or phenylalkyl or in which R⁴ and R⁵ together form part of a 5- to 7-membered saturated nitrogen heterocycle that may additionally contain a nitrogen or oxygen atom as a ring member (for example, a piperidine, piperazine, pyrrolidine, imidazoline, or morpholine ring) and R⁶ represents hydrogen.

In particular, R¹, R², and R³, independently of one another, denote —NH₂, —NH—CH₃, —NH—C₂H₅, —N(CH₃)₂, —N(C₂H₅)₂, —NH—CH₂CH₂OH, —NH—(C₂-C₄-hydroxyalkyl), —N(C₂-C₄-hydroxyalkyl)₂—NH—CH₂CH₂SO₃H; —NH—CH₂—CH₂—O—CH₂—CH₂—OH, —OCH₃, —OCH(CH₃)₂, —O—CH₂—CH₂—O—CH₃, —N(CH₂—CH₂—OH)₂, —N(CH₂—CHOH—CH₃)₂, morpholino, —SCH₃, —N(CH₂—CH₂—OH)CH₂—CH₂—CONH₂, and one of the following radicals

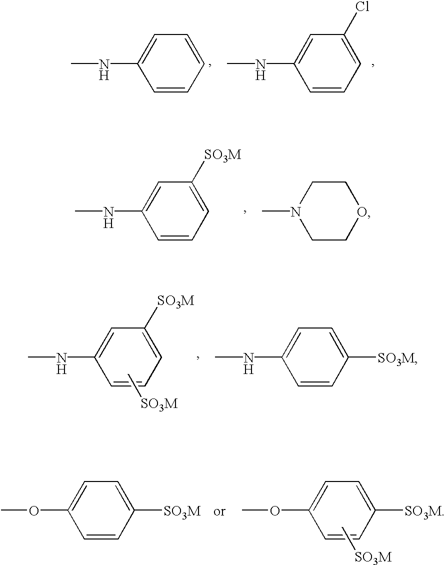

Preferred amino acid radicals are derived, for example, from glycine, sarcosine, β-alanine, aspartic acid, or iminodiacetic acid.

M is preferably H, Na, Li, K, Ca, Mg, ammonium, or ammonium that is mono-, di-, tri-, or tetrasubstituted by C₁-C₄-alkyl, C₂-C₄-hydroxyalkyl, or a mixture thereof. The optical brighteners are preferably present in the form of their salts, particularly as Na or K salts.

Optical brighteners of the formula (I) in which

R¹ and R² represent —N(CH₂—CH₂—OH)₂,

R³ represents

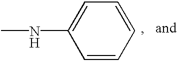

M has the above meaning (particularly Na⁺ or K⁺), are particularly preferred.

The optical brighteners from the distilbene series are described, for example, in EP-A 385,374.

The cationic brightener can be obtained, for example, by cationization of anionic brighteners, particularly those containing sulfo and/or carboxyl groups, for example, by means of polymeric quaternary ammonium compounds. Such brighteners are described, for example, in WO-A 99/67,317.

Optionally, the aqueous brightener preparations may contain a small amount (preferably <10% by weight) of further auxiliaries. For example, formulation auxiliaries, such as standardizing agents, surface-active compositions and/or antifoams, and organic thickeners (protective colloids), preservatives, and/or electrolytes may be mentioned as such. However, for ecological reasons, the aqueous brightener preparations preferably contain only very small amounts of organic additives, auxiliaries, and/or impurities, particularly altogether less than 3% by weight (very particularly less than 1% by weight), relative to brightener of component (a). Particularly preferably, the aqueous preparations contain no organic cosolvents.

Sodium chloride, sodium sulfate, sodium carbonate, or one of the corresponding potassium salts or mixtures of said substances may be mentioned as an electrolyte. The amount of electrolyte may be less than or equal to 2% by weight (preferably 0.001 to 2% by weight, particularly 0.001 to 0.5% by weight), relative to the total weight of the aqueous preparation.

In particular, the aqueous brightener preparations to be used according to the invention may contain formulation auxiliaries of component (c), preferably 0.1 to 5% by weight, relative to component (a) of the preparation, of at least one condensate based on

(A) sulfonated aromatics,

(B) aldehydes and/or ketones, and

(C) optionally, one or more compounds selected from the group consisting of the unsulfonated aromatics, urea, and urea derivatives.

In the context of this application, sulfomethylated aromatics are also understood as being sulfonated aromatics of component (A). Preferred sulfonated aromatics are naphthalenesulfonic acids, phenolsulfonic acids, dihydroxybenzenesulfonic acids, sulfonated ditolyl ethers, sulfomethylated 4,4′-dihydroxydiphenyl sulfone, sulfonated diphenylmethane, sulfonated biphenyl, sulfonated hydroxybiphenyl (particularly 2-hydroxybiphenyl), sulfonated terphenyl, or benzenesulfonic acids.

Particularly suitable aldehydes and/or ketones of component (B) are aliphatic, cycloaliphatic, and aromatic aldehydes and/or ketones. Aliphatic aldehydes are preferred, with formaldehyde and other aliphatic aldehydes having 3 to 5 carbon atoms being particularly preferred.

Examples of suitable unsulfonated aromatics of component (C) are phenol, cresol, 4,4′-dihydroxydiphenyl sulfone, or dihydroxydiphenyl-methane Examples of suitable urea derivatives are dimethylolurea, melamine, or guanidine.

A preferably used condensate of component (c) is one based on

(A) at least one sulfonated aromatic selected from the group consisting of phenolsulfonic acids, dihydroxybenzenesulfonic acids, sulfo-methylated 4,4′-dihydroxydiphenyl sulfone, sulfonated diphenyl-methane, sulfonated diphenyl, sulfonated hydroxybiphenyl (particularly 2-hydroxybiphenyl), sulfonated terphenyl, and benzenesulfonic acids, particularly naphthalenesulfonic acids and sulfonated ditolyl ethers,

(B) formaldehyde, and

(C) optionally, one or more compounds selected from the group consisting of phenol, cresol, 4,4′-dihydroxydiphenylsulfone, dihydroxydiphenylmethane, urea, dimethylolurea, melamine, and guanidine.

The condensate preferably obtained in the condensation preferably has an average degree of condensation of 1 to 150, particularly preferably 1 to 20, particularly 1 to 5.

The condensates of component (c) can be used as an aqueous solution or suspension or as a solid, for example, as a powder or granules, preferably as a spray-dried powder or granules.

Preferred condensates of component (c) have an inorganic salt content of less than 10% by weight (preferably less than 5% by weight, particularly less than 1% by weight), relative to the aqueous solution or suspension of the component used or relative to the solid of component (c) used.

It is also preferable to use condensates of component (c) that have a low residual monomer content or are free of residual monomers.

The term “having a low monomer content” is understood as meaning a residual monomer content of less than 30% by weight (preferably less than 20% by weight, particularly <10% by weight, preferably <5% by weight), relative to the condensate. In this context, residual monomers are understood as meaning the reactants used for the preparation of the condensate.

Such condensates having a low salt content and low content of residual monomers are disclosed, for example, in EP-A 816,406.

The condensates of component (c) can be prepared, for example, by first preparing the sulfonated aromatics of component (A), optionally as a mixture with unsulfonated aromatics of component (C), by reacting the parent aromatics with a sulfonating agent, preferably sulfuric acid, particularly concentrates of sulfuric acid, chlorosulfonic acid, amidosulfonic acid, or oleum.

Preferably 0.4 to 3.2 mol (particularly 0.8 to 1.6 mol) of sulfonating agent are used per mol of the parent aromatic of component (A).

The condensation with aldehydes and/or ketones of component (B), preferably formaldehyde, optionally together with further compounds of component (C), is then carried out. The condensation is preferably carried out in aqueous solution at a pH of 0 to 9. Here, 0.4 to 1.5 mol (particularly 0.4 to 1.0 mol) of component (B) are preferably used per mol of sulfonated aromatic (A) or per mol of a mixture of sulfonated aromatic of component (A) and unsulfonated aromatic of component (C).

This step is optionally followed by the neutralization of the sulfonic acid-containing condensate of component (c) with a base.

Separating the inorganic acid or its salts and reducing the residual monomer content can be carried out, for example, by membrane separation methods. Preferred membrane separation methods are ultrafiltration, diffusion dialysis, or electrodialysis. The membranes used in the membrane separation methods, preferably in ultrafiltration, have a molecular weight cut-off (MWCO) of 1000 to 10,000 Dalton in a preferred embodiment.

The inorganic acid is separated with the aid of a membrane separation method, preferably by diafiltration using acid-stable ultra-filtration or nanofiltration membranes in a crossflow filtration procedure. For example, polyhydantoin membranes, as disclosed in EP-A 652,044, may be mentioned as suitable membranes.

Preferred membranes for this purpose have an MWCO level of 2000 to 10,000 Dalton. Optionally, concentration is simultaneously effected in this process step.

Furthermore, the aqueous brightener preparations may also contain organic thickeners. Thickeners from the group consisting of the anionic or nonionic organic water-soluble polymers may be mentioned as suitable thickeners. Organic thickeners that have a solubility in water of >100 g/l are particularly preferred. A preferably used organic thickener is a compound for which a 4% strength aqueous solution has a viscosity of ≧2 mPa.s at 20° C.

Preferred organic thickeners are compounds selected from the following groups:

dextrins or cyclodextrins,

starch and starch derivatives, particularly degraded or partly degraded starch,

anionic polyhydroxy compounds, particularly xanthan or carboxymethylcellulose,

cellulose derivatives, such as, for example, methylcellulose, particularly hydroxymethylcellulose, hydroxyethylcellulose, or hydroxypropylcellulose,

partially hydrolyzed polymers of vinyl acetate, preferably polyvinyl alcohol, that have a degree of hydrolysis of more than 70%, and/or vinyl alcohol copolymers, preferably copolymers of vinyl acetate and alkyl vinyl esters, that are partially or completely hydrolyzed, and polyvinyl alcohol itself,

polymers of N-vinylpyrrolidone or copolymers with vinyl esters,

polyacrylamides, preferably nonionic or anionic polyacrylamides.

Starch, derivatized starch, and, particularly, degraded starch are preferably suitable as thickeners.

Degraded starch is obtained, for example, by subjecting, for example, natural potato starch, wheat starch, maize starch, rice starch, or tapioca starch to an oxidative, thermal, enzymatic, or hydrolytic degradation. Oxidatively degraded starches are preferred, with potato starch that is oxidatively degraded with hypochlorite being particularly preferred.

Furthermore, dextrins and cyclodextrins are particularly suitable. Dextrins are understood as meaning preferably white dextrins, yellow dextrins, and maltodextrins having a solubility in cold water of >50% by weight (preferably >90% by weight), measured with 10 g per 200 ml of water at 20° C.

Preferred cyclodextrins are those of the type α-CD having 6 glucopyranose units, β-CD having 7 glucopyranose units, and γ-CD having 8 glucopyranose units, and branched AB, AC, and AD-diclosyl-CD and mixtures of said dextrins.

Preferred anionic polyhydroxy compounds are polysaccharides, particularly xanthan and carboxymethylcellulose.

Cellulose derivatives that may be used as thickeners are preferably methylcellulose, hydroxymethylcellulose, hydroxyethylcellulose, and hydroxypropylcellulose.

In particular, at least partly hydrolyzed (saponified) polymers and copolymers of vinyl acetate that are completely dispersible, preferably completely soluble, in water are suitable as thickeners. Hydrolyzed polymers and copolymers of vinyl acetate having a degree of hydrolysis of 70 to 97% (preferably of 80 to 92%), a molecular weight of 1000 to 150,000 g/mol (preferably 2000 to 100,000 g/mol), and an efflux viscosity (determined using a 4% strength aqueous solution at 20° C.) of 2 to 35 mPa.s (preferably 2 to 10 mPa.s) are preferred.

Partially hydrolyzed polyvinyl alcohols and polyvinyl alcohol itself are particularly preferred.

Copolymers of vinyl acetate as thickeners are understood as meaning, in particular, completely or partially hydrolyzed vinyl alcohol copolymers, particularly completely hydrolyzed copolymers of alkyl vinyl esters and vinyl acetate containing preferably 5 to 20 mol % of alkyl vinyl esters, very particularly copolymers of alkyl vinyl acetate and vinyl acetate.

Furthermore, homo- and copolymers of N-vinylpyrrolidone that are completely dispersible in water are suitable as thickeners.

The molecular weight of the homo- and copolymers of N-vinyl-pyrrolidone is 2000 to 1,200,000 g/mol, preferably 10,000 to 150,000 g/mol.

Homopolymers of N-vinylpyrrolidone and copolymers with vinyl esters and Na methacrylate are very particularly preferred.

In a particular embodiment, the aqueous brightener preparations may contain crystallization inhibitors, such as, for example, cholesterol, vanillin, and/or compounds selected from the group consisting of terpenes, terpenoids, fatty acids, and/or fatty acid esters.

The brighteners of component (a), particularly of the general formula (I), are either known or can be prepared by known methods and are as a rule used as free acid or as salts thereof, preferably alkali metal salts.

The preparation of the concentrated aqueous brightener preparations is preferably carried out by introducing the water-moist press cake and/or the dry form of a compound of the formula (I) into water, preferably demineralized water, that is already at a temperature of 40 to 98° C. or into water that still has to be brought to a temperature of 40 to 98° C. Said auxiliaries and/or electrolytes can optionally be added before, during, and/or after the introduction.

In a particularly preferred embodiment, the water-moist press cake of the free acid of at least one brightener of component (a) is introduced into water at a temperature of 40 to 98° C. (preferably 60 to 95° C.) and is adjusted to a pH of 8 to 12 (particularly 8.5 to 10) with a base, preferably an alkali metal hydroxide. The aqueous brightener preparations that are thus obtained and are to be used according to the invention can optionally be freed from undissolved components and undesired by-products from the brightener synthesis (e.g., triazines), for example, by clarifying filtration. After said pH adjustment or before or after a possible clarifying filtration, the aqueous preparations can be adjusted to a desired brightener concentration with water, optionally together with auxiliaries.

The method according to the invention is preferably carried out by combining the aqueous brightener preparation, optionally after dilution with water, with the natural or synthetic materials, particularly fiber materials, that are preferably introduced into an aqueous pulp mixture, paper coating slip, or size press or film press liquor.

In a further preferred embodiment, the aqueous brightener preparations of component (a) that are to be used according to the invention can be obtained by converting a solid brightener preparation or the dried brightener of component (a) into a solution by an aqueous base at a temperature of 40 to 98° C. (preferably 60 to 95° C.) and a pH of 8 to 12 (preferably 8.5 to 10), after which a clarifying filtration can optionally be effected.

A particularly preferred process for the preparation of the aqueous brightener preparations to be used according to the invention is one in which the synthetic product of the brightener of component (a) is converted directly into the aqueous brightener preparation without isolation of the synthetic product in solid form. For this purpose, it may be necessary to bring the pH and the temperature of the synthetic product into the above-mentioned ranges. If required, water, excess starting materials, or by-products of the synthesis can be separated, for example, by phase separation. The aqueous preparations thus obtained can optionally then also be subjected to a clarifying filtration as described above and generally operated batchwise.

Instead of the clarifying filtration, the aqueous preparations can also be filtered by continuous methods, such as, for example, microfiltration or ultrafiltration methods, and optionally concentrated. For example, salts and low molecular weight components still present can also be particularly efficiently eliminated thereby.

According to the invention, the aqueous brightener preparations can also be prepared by combination of such processes.

Regarding the use of the aqueous brightener preparations for the optical brightening of natural and synthetic materials, particularly fiber materials in aqueous dying liquors or media, there is no restriction according to the invention. The use therefore relates, for example, to the brightening of textiles by known dyeing processes and the use for brightening detergents.

In particular, the use according to the invention of the aqueous brightener preparations relates to the brightening of paper pulps in papermaking (“wet-end coloring”), for example, chemical and mechanical pulp, brightening of the coating slips usually used in the paper industry, and particularly the brightening of filler-free, but particularly of filler-containing paper stocks and of pigmented coating slips, and brightening in the size press or film press.

In a preferred embodiment of the method according to the invention, the temperature of the aqueous brightener preparation from the time of its formulation or preparation to directly at introduction into the medium of use or at any required preliminary dilution is in a range of 10 to 98° C. (preferably 40 to 98° C.) over the duration of storage and of transport.

In the case that the aqueous preparation partly or completely solidifies or precipitates during longer storage or transport times at lower temperature, it is preferable according to the invention to increase the temperature, e.g. by heating the storage tank or transport container, before use until the brightener is re-dissolved completely and the aqueous preparation is free of precipitates. For the method according to the invention, it is furthermore preferable if the brightener preparation has a temperature of 40 to 98° C. immediately before introduction into the medium of use. Particularly preferably, the temperature of the aqueous preparation is adjusted so that a complete solution of the brightener is introduced into the medium.

The method according to the invention is preferably carried out by combining the aqueous brightener preparation, optionally after dilution with water, with the natural or synthetic materials, particularly fiber materials, that are preferably introduced into an aqueous pulp mixture, paper coating slip, or size press or film press liquor.

The method according to the invention for the optical brightening of paper in the pulp and/or at the surface is preferably carried out by diluting the aqueous brightener preparation continuously or batchwise (preferably continuously) to a concentration of 0.01 to 40% by weight (particularly 1 to 25% by weight), relative to the component (a), at a temperature of 15 to 75° C. (particularly 20 to 55° C.) and a pH of 6.0 to 12 (particularly 6.5 to 11, very particularly 6.5 to 9.5), as a solution with water, followed by addition to the aqueous pulp mixture, paper coating slip, or size press or film press liquor or by introduction undiluted into said media of use in the form of the aqueous brightener preparations themselves, preferably at a temperature of 40 to 98° C.

In wet-end coloring, the aqueous brightener preparation itself or an aqueous dilution thereof can be added to the paper stock at any stage of the papermaking process prior to sheet formation.

The term “continuous” may be understood as meaning that both the aqueous brightener preparation and an aqueous medium, generally water, are continuously combined in a desired ratio, for example, in a stirred container or in a pipeline, and the mixture thus obtained is fed to the stock stream or to the dilution water of the paper machine in the desired ratio.

The known coating slips generally contain as binder inter alia plastics dispersions based on copolymers of butadiene-styrene, acrylo-nitrile-butadiene-styrene, acrylates, ethylene-vinyl chloride, or ethylene-vinyl acetate or based on homopolymers, such as polyvinyl chloride, polyvinylidene chloride, polyethylene, polyvinyl acetate, or polyurethanes. A preferred binder consists of styrene-butyl acrylate or styrene-butadiene-acrylic acid copolymers. The further polymer latices are described, for example, in U.S. Pat. No. 3,265,654.

Aluminum silicates, such as china clay and kaolin, as well as barium sulfate, satin white, titanium dioxide, or calcium carbonate, in natural or precipitated form, are usually used for pigmenting the coating slips.

These coating slips preferably contain 5 to 75% by weight of at least one white pigment. The binder is preferably used in an amount which is sufficient for the solids content of polymer compound to account for 1 to 30% by weight (preferably 5 to 25% by weight) of the white pigment. The amount of the aqueous brightener preparation to be used according to the invention is calculated so that the brightener of component (a) is present in amounts of 0.005 to 2% by weight (particularly 0.01 to 1.5% by weight), relative to white pigment.

The coating slips can be prepared, for example, by mixing the components in any desired order at temperatures of 10 to 100° C., preferably 20 to 80° C. Here, the components also include the customary auxiliaries that can be used for regulating the Theological properties, such as viscosity or water retention, of the coating slips. Such auxiliaries are, for example, natural binders, such as starch, casein, protein, or gelatin, cellulose ethers, such as carboxyalkylcellulose or hydroxyalkylcellulose, alginic acid, alginates, polyethylene oxide or polyethylene oxide alkyl ethers, copolymers of ethylene oxide and propylene oxide, polyvinyl alcohol, polyvinylpyrrolidone, water-soluble condensates of formaldehyde with urea or melamine, polyphosphates, or salts of polyacrylic acid.

The aqueous brightener preparations to be used according to the invention are incorporated either into the prepared coating slip or into one of the components of the coating slip. The aqueous preparations can be added directly or likewise added in the form of aqueous dilutions. Aqueous dilutions are optionally prepared continuously and introduced continuously into the process of the so-called intermediate step.

The coating slip can be used for coating cellulose-based materials, particularly paper, wood, films, such as, for example, cellulose, cellulose triacetate, cotton textile fabrics, and the like. The use on paper, board and cardboard, and photographic papers is particularly preferred.

The coating slips can be applied to the substrate by any conventional method, for example, using an air knife, a coating knife, a brush, a roller, a doctor blade, or a rod, after which the coating is dried, for example, using an infrared dryer, hot-air dryer, and/or contact dryer, at temperatures of the substrate surface in the range of 60 to 200° C. (preferably of 90 to 130° C.) to a residual moisture content of 3 to 6% by weight.

As a result of the use of the coating slips, the coatings obtained are furthermore distinguished by an optimum distribution of the optical brighteners over the entire surface and a consequent increase in the whiteness and high lightfastness.

The aqueous brightener preparations to be used according to the invention are furthermore distinguished by a number of advantages. As liquid preparations, they are readily meterable, very readily storable at a temperature of 40 to 98° C. (particularly above 60° C.) and can easily be transported and, if required, also stored in insulated, preferably heated containers, such as, for example, road tank containers, as well as in large units. Because of the very good stability of these preparations, it is possible to dispense with stirred tanks during storage.

Very particularly, aqueous brightener preparations are readily dilutable in water at a pH above 6.5 and a temperature of 15 to 55° C., particularly cold water, in any desired concentrations and immediately form residue-free mixtures, preferably solutions, that are stable in said temperature and pH range over a period sufficient for processing. In particular, aqueous dilutions having a content of 0.01 to 15% by weight are stable in said pH and temperature range over a period of at least 1 hour.

The aqueous brightener preparations can be used for surface application in the customary liquors for the size press or film press and are added in portions or continuously in the form of the aqueous preparations themselves or dilutions prepared therefrom.

The following examples further illustrate details for the method of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

### Example 1

700 ml of water and 10 g of sodium chloride were introduced into a reactor A and stirred for 10 min. Thereafter, 1.0 g of a polyether obtained from isodecyl alcohol, 6 mol of ethylene oxide, and 8 mol of propylene oxide was added while stirring and the mixture was cooled to about 10° C. 100 g of cyanuric chloride (0.542 mol) were introduced while stirring, rinsing was effected with 100 ml of water, and the suspension was stirred until the pH had decreased to 4.5. An aqueous solution that had been cooled to 10° C. and contained 0.3 mol of 4,4′-diaminostilbene-2,2′-disulfonic acid disodium salt and 0.3 mol of sodium carbonate in 1200 ml was titrated to the reaction mixture, the temperature of the reaction mixture being allowed to increase to 18° C. An automatic titrator adjusted to the upper limit of pH 4.5 was used for the addition. Theoretically, 1084 ml could be consumed. The end point of the reaction was reached when less than 5 ml were consumed over the course of 10 minutes, which in this case occurred after 2 to 2.5 hours with a consumption of 99% of theory. A readily stirrable pale yellow suspension formed. The titrator solution was changed. The titrator solution contained 250 g of 10% strength sodium hydroxide solution. The pH was adjusted to 6.8 with 7 g of 10% strength sodium hydroxide solution. 49.5 g of aniline (0.53 mol) were then allowed to run in over the course of 30 minutes, the temperature in the reactor being allowed to increase to 25° C. Stirring was continued for 1.5 hours at 25° C. Up to this time, 215 g of 10% strength sodium hydroxide solution (0.54 mol) had been metered in via the titrator. The pick-up was less than 2 ml in 10 minutes at the end of the subsequent stirring time.

300 ml of water were initially introduced into a second reactor B, 84 g of an 80% strength diethanolamine solution (0.64 mol) were added, and the mixture was heated to 95° C. The content was transferred from reactor A into reactor B over the course of 1.5 hours. The temperature in reactor B was kept constant at 95° C. and the pH at 7.5 by titration with 10% strength sodium hydroxide solution. Heating was then effected for 2.5 hours to 98-100° C. with continued titration. Consumption of 10% strength sodium hydroxide solution was 180 g (0.45 mol). The mixture was allowed to cool to 85° C. and a pH of 4.2 was established at this temperature by adding hydrochloric acid. Stirring was continued for 30 min and the temperature was allowed to decrease to 50-55° C. during this procedure. The product was filtered off and carefully washed with water. After drying at 50° C. in vacuo, 245 g of product having a E1/1 value of 600 (specific extinction measured at 350 nm wavelength) were obtained. The product corresponded to the compound of the formula

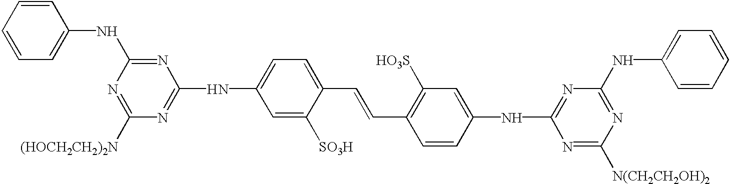

430 ml of water were then initially introduced into a reactor and heated to about 90° C. The total product was then added in three equal portions, each portion being brought into solution by adding 70 g of 10% strength sodium hydroxide solution. The pH of the resulting yellow-brown cloudy solution was adjusted to 8.9 with 10% strength sodium hydroxide solution. Filtration was effected at 80-90° C. through a deep-bed filter, and 890 g of a clear solution having an E1/1 value of 165 (measured at 350 nm wavelength) were obtained.

The aqueous brightener preparation thus obtained had a shelf-life of more than 30 days at a temperature of 75° C. and showed no crystalline precipitates or separation.

### Example 2

A clear solution of the same brightener was prepared according to the process described in Example 1 and 0.5% by weight of Baykanol®SL (Bayer AG, formaldehyde condensate from component (c) based on sulfonated ditolyl ether), relative to the brightener active ingredient, was added after the deep-bed filtration at a temperature of 90° C. while stirring and was completely dissolved. A clear solution having an E1/1 value of 157 (measured at 350 nm wavelength) was obtained.

This aqueous brightener preparation had a shelf-life of more than 30 days at a temperature of 65° C. and showed no crystalline precipitates or separation.

### Example 3

A clear solution of the same brightener was prepared according to the process described in Example 1 and 1.9% by weight of a 28% strength aqueous solution of a formaldehyde condensate of 4,4′-dihydroxydiphenyl sulfone and naphthalenesulfonic acid, which was desalinated and brought to a low residual monomer content by a crossflow ultrafiltration as described in Example 5 of EP-A 1,049,745, were introduced after the deep-bed filtration at a temperature of 90° C. and were completely dissolved. A clear solution having an E1/1 value of 155 (measured at 350 nm wavelength) was obtained.

The aqueous binder preparation had a shelf-life of more than 30 days at a temperature of 65° C. and showed no crystalline precipitates or separation.

### Example 4

A solution prepared according to Example 2 was spray-dried by means of an airless high-pressure nozzle dryer with an air inlet temperature of 220° C. and an outlet temperature of 90° C. with recycling of fine material. A solid in the form of microgranules having a residual moisture content of 5.6% by weight (determination by means of IR drying) and an E1/1 value of 550 was obtained. This solid dissolved completely in demineralized water at 90° C. at a pH of 8.7 with a concentration of up to 75% by weight. The resultant aqueous brightener preparation having an E1/1 value of 445 (measured at 350 nm wavelength) had a shelf-life of more than 14 days at a temperature of 85° C. and showed no crystalline precipitates or separation and still had a liquid, in particular pumpable, consistency.

### Example 5

### Use According to the Invention in the Wet-End Coloring of Paper

200 ml of a 2.5% strength aqueous pulp mixture containing 30 parts of Nordic long-fiber sulfate pulp and 70 parts of Nordic short-fiber sulfate pulp were initially introduced into a laboratory sheet former and made up with 800 ml of demineralized water, 0.4% by weight (relative to the solids content of the pulp mixture) of each of the hot aqueous brightener preparations of Examples 1-3 were then introduced while stirring and, after stirring for 10 minutes, the sheet was formed manually on the screen. The sheets thus obtained were then carefully dried on a drying cylinder at a temperature of 95° C. and conditioned for a period of 12 hours at 23° C. and 50% relative humidity.

These hand-made paper sheets exhibited high whiteness and excellent levelness.

### Example 6

### Use According to the Invention in the Wet-End Coloring of Paper

Paper sheets having comparably good white aspect and excellent levelness were likewise obtained as described in Example 5 but with addition of 0.16% by weight of hot aqueous brightener preparation according to Example 4.

### Example 7

### Use According to the Invention in the Paper Coating

Brightener-free and wood-free DIN A4 base papers (basis weight 80 g/m²) were coated on a laboratory doctor blade apparatus (from Erichsen, K-Control-Coater, model K 202) with coating slips having the following composition:

60 parts of calcium carbonate

40 parts of kaolin

10 parts of SBR latex

1 part of polyvinyl alcohol

0.25 part of polyacrylic acid

The pH of the coating slip was adjusted to 8-8.5 with dilute sodium hydroxide solution and the solids content of the coating slip was adjusted to 60-65% by adding water. The coating slip was divided into 3 parts, and the hot aqueous brightener preparations described in Examples 1 to 3 were introduced homogeneously into one part each of the coating slip, in an amount of 10 g, relative to 1 kg of coating slip, and mixed for a period of 10 min.

The sheets coated in this manner were dried for 1 min at 95° C. in a drying cylinder and then stored for 3 hours at 23° C. and a relative humidity of 50% before they were measured. In all three cases, papers having very high whiteness and good levelness resulted.

### Example 8

### Use According to the Invention in the Paper Size Press

Brightener-free and wood-free DIN A4 base papers (basis weight 80 g/m²) were treated on a laboratory size press (from Werner Matthis AG, TYPE No. HF 18374) with aqueous liquors containing 50 g/l of starch and 2 g/l of the aqueous brightener preparations corresponding to the composition from Examples 1 to 3, which were introduced in their hot form. The pH of the liquors was about 7 and the wet pick-up was about 50-60%.

The sheets were then dried for 1 min at 95° C. in a drying cylinder and then stored for 3 hours at 23° C. and a relative humidity of 50% before they were measured. In all three cases, papers having very good whiteness resulted.

### Example 9

### Continuous Process According to the Invention for Continuous Dissolution and for use in the wet-end coloring of Paper

An aqueous brightener preparation prepared according to Example 1 and having a temperature of 75° C. was passed continuously by means of a heated gear pump, over a period of 1 hour (steady-state operation), in an amount of 350 kg/h together with 650 l/h of partly demineralized water at 45° C., into a stirred container having a capacity of 50 liters and provided with a propeller stirrer, and at the same time 1000 kg/h of the concentrated solution thus obtained were removed at the bottom by means of a rotor-stator pump. The aqueous preparation was introduced in the vicinity of the stirrer at the 70% filling level of the container. The stirrer speed was adjusted so that a sufficient mixing effect with little froth formation was achieved. In the steady state, the container content was about 35 liters and the average residence time of the mixture in the stirred container was 2.1 minutes. Samples taken at intervals of 5 min behind the discharge pump contained the desired clear solution with a specific extinction of 57±0.5 at 350 nm. The solution was stable to precipitation for more than 3 hours (with cooling to room temperature). The concentrated solution thus obtained was therefore excellently suitable for being continuously metered in the desired ratio (desired concentration of the brightener active ingredient) into the stock stream of a paper machine.

By means of the process described, it was also possible to formulate sufficiently stable, clear solutions up to a concentration of more than 18% by weight of the brightener active ingredient.

By means of the same process, it was also possible continuously to dissolve the aqueous brightener preparations according to the compositions from Examples 2 and 3 with a comparably good result. However, the dissolution stability with the aqueous brightener preparation from Example 2 was more than 6 hours, and it was possible to obtain clear solutions sufficiently stable at room temperature up to a concentration of more than 22% by weight of the brightener active ingredient. The aqueous brightener preparation from Example 3 exhibited even better dissolution stability even at concentrations above 22% by weight of the brightener active ingredient.

### Example 10

### Use on Cotton, Pad Drying Process

Boiled and bleached woven cotton fabric was padded on the laboratory padding machine using various aqueous liquors which contained in each case the following:

14 g/l of brightener active ingredient from Examples 1-4 and

3 g/l of sodium sulfate.

The addition of the brightener active ingredient was effected with stirring by introducing the corresponding amount of hot aqueous brightener preparation from Examples 1 to 4 and then adding sodium sulfate. The liquor pick-up of the fabric was adjusted to about 80% by squeezing out between the padding machine rolls. Immediately thereafter, the fabric was dried by passage through a tenter frame at 100° C. for 30 seconds.

As a result of this treatment, a very good brightening effect was achieved on the fabric in each case.

### Example 11

### Use on Cotton, Dry Crosslinking

Boiled and bleached cotton poplin was impregnated on a laboratory padding machine with various aqueous liquors based on the aqueous preparations of Examples 1 to 4 and having the following composition:

14 g/l of brightener active ingredient from Examples 1-4 and

105 g/l of a synthetic resin precondensate mixture consisting of

80 g/l of Fixapret®NF (product of BASF) and

25 g/l of Condensol® N (product of BASF).

The brightener active ingredient was added, in each case while stirring, by introducing the corresponding amount of hot aqueous brightener preparation from Examples 1 to 4. The fabric was squeezed off between rolls to a liquor pick-up of about 80% of the dry weight. Drying was then carried out on the tenter frame at 100° C. for 30 seconds. Condensation was likewise effected on the tenter frame at 150° C. for 4 minutes.

As a result of this treatment, a very good whitening effect was achieved on the fabric in each case.

What is claimed is:

1. A method comprising optically brightening natural or synthetic materials with an aqueous brightener preparation comprising
(a) 15 to 85% by weight of at least one water-soluble optical brightener, and
(b) optionally, 85 to 15% by weight of water,
wherein the temperature of the preparation is 40 to 98° C.

2. A method according to claim 1 wherein 20 to 65% by weight of at least one water-soluble optical brightener is used.

3. A method according to claim 1 wherein the temperature of the aqueous brightener preparation is 60 to 95° C.

4. A method according to claim 1 wherein the brightener preparation is free of crystalline brightener particles.

5. A method according to claim 1 wherein the water-soluble optical brightener is selected from the group consisting of brighteners containing sulfo and/or carboxyl groups.

6. A method according to claim 5 wherein the water-soluble optical brightener is a stilbene compound.

7. A method according to claim 1 wherein the water-soluble optical brightener is selected from the group consisting of distilbenes and triazinylfiavonates of the formula (I) 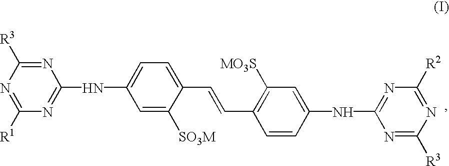
in which
R¹, R², and R³, independently of one another, denote phenoxy; mono- or disulfonated phenoxy; phenylamino; mono- or disulfonated phenyl-amino; phenylamino substituted by C₁-C₃-alkyl, cyano, halogen, COOR, CONH—R, NH—COR, SO₂NH—R or O—R; morpholino; peridino; pyrrolidino; —O(C₁-C₄-alkyl); —NH(C₁-C₄-alkyl); —N(C₁-C₄-alkyl)₂; —NH(C₂-C₄-alkylene)—OR; —N(C₂-C₄-hydroxyalkyl)₂; —NH(C₂-C₄-alkylene)—O—(C₂-C₄-alkylene)-OR; an amino acid or an amino acid amide from which a hydrogen atom has been removed from the amino group; —NHCH₂CH₂OH; —N(CH₂CH₂OH)₂; —N(CH₃)(CH₂CH₂OH); —NH₂; —OCH₃; —S—-C₁-C₄-alkyl; —S-aryl; —Cl; —NH—CH₂CH₂SO₃H; —N(CH₂CH₂SO₃H)₂; or —N(CH₂CH₂OH)CH₂CH₂CONH₂, and
R denotes H or C₁-C₃-alkyl, and
M denotes the radical of an alkali metal, alkaline earth metal, ammonium, or amine salt.

8. A method according to claim 1 wherein the water-soluble optical brightener is selected from the group consisting of triazinyl-flavonates of the formula (I) 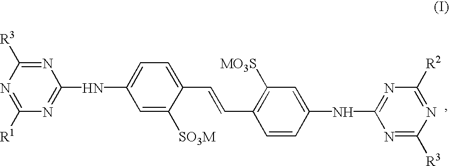
in which
R¹, R², and R³, independently of one another, denote —NH₂, —NH—CH₃, —NH—C₂H₅, —N(CH₃)₂, —N(C₂H₅)₂, —NH—CH₂CH₂OH, —NH—(C₂-C₄-hydroxyalkyl), —N (C₂-C₄-hydroxyalkyl)2, —NH—CH₂CH₂SO₃H,—NH—CH₂—CH₂—O —CH₂—CH₂—OH, —OCH₃, —OCH(CH₃)₂, —O—CH₂—CH₂—O—CH₃, —N(CH₂—CH₂—OH)₂, —N(CH₂—CHOH—CH₃)₂, morpholino, —SCH₃, —N(CH₂—CH₂—OH)CH₂—CH₂—CONH₂, or one of the following substituents 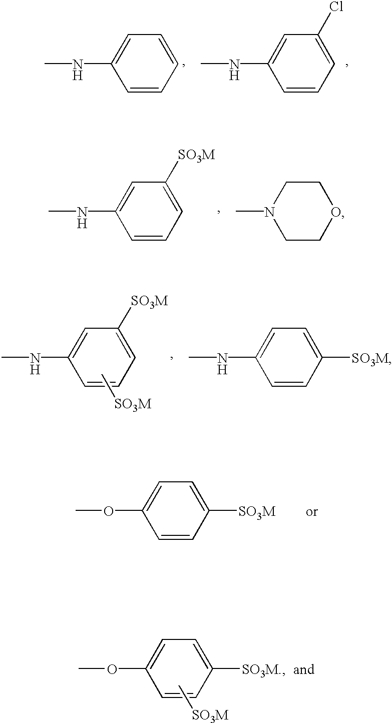
M denotes the radical of an alkali metal, alkaline earth metal, ammonium or amine salt.

9. A method according to claim 4 wherein
R¹ and R² represent —N(CH₂—CH₂—OH)₂,
R³ represents 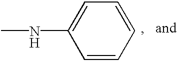
M denotes the radical of an alkali metal, alkaline earth metal, ammonium, or amine salt.

10. A method according to claim 9 wherein M is Na or K.

11. A method according to claim 1 additionally containing
(c) 0.1 to 5% by weight, relative to the water-soluble optical brightener, of at least one condensate based on
(A) sulfonated aromatics,
(B) aldehydes and/or ketones, and
(C) optionally, one or more compounds selected from the group consisting of the unsulfonated aromatics, urea, and urea derivatives.

12. A method according to claim 11 wherein component (c) is a condensate based on
(A) ditolyl ether sulfonic acid and
(B) formaldehyde.

13. A method according to claim 11 wherein component (c) is a condensate based on
(A) naphthalenesulfonic acid,
(B) formaldehyde, and
(C) 4,4′-diphenylsulfone.

14. A method according to claim 1 for optically brightening paper in the pulp.

15. A method according to claim 1 for optically brightening paper at the surface.

16. A method according to claim 1 for optically brightening paper at the surface using paper coating slips or size press or film press liquors.

17. A method according to claim 1 wherein the aqueous brightener preparation, optionally after dilution with water, is combined with a synthetic or natural material.

18. A method according to claim 17 wherein the synthetic or natural material is a fiber material.

19. A method according to claim 17 wherein the aqueous brightener preparation, optionally after dilution with water, is combined with a synthetic or natural materials by introduction into an aqueous pulp mixture, paper coating slip, and/or size press or film press liquor

20. A method according to claim 1 wherein the aqueous brightener preparation is introduced into water at a concentration of 0.01 to 40% by weight, relative to the water-soluble optical brightener, at a temperature of 10 to 75° C. and a pH of 6.0 to 12 and is then added to the aqueous paper pulp.

21. A method according to claim 1 for optically brightening polyamide, cellulose, paper, or detergents.
